(19) United States
(12) Patent Application Publication
(10) Pub. No.: US 2013/0117037 A1
(43) Pub. Date: May 9, 2013

(54) Goal Tracking and Segmented Marketing Systems and Methods with Network Analysis and Visualization

(71) Applicant: Rivermark LLC, Doylestown, PA (US)

(72) Inventors: John H. Eichert, JR., New Hope, PA (US); D. Bruce West, New Hope, PA (US); Steven J. Eichert, Telford, PA (US); Michael Petro, Lower Gwynedd, PA (US)

(73) Assignee: RIVERMARK LLC, Doylestown, PA (US)

(21) Appl. No.: 13/659,473

(22) Filed: Oct. 24, 2012

Related U.S. Application Data
(60) Provisional application No. 61/550,846, filed on Oct. 24, 2011.

(51) Int. Cl. G06Q 30/02

(52) U.S. Cl. CPC G06Q 30/0204
USPC 705/2; 705/7.33

(57) ABSTRACT

Systems and methods for establishing and studying networks of professionals and how they associate, learn, and behave are disclosed. In methods according to embodiments of the invention, networks of professionals are defined by administering sociometric surveys to a group of professionals, or by culling already available data about the professionals from other data sources. Behavioral data is also imported, and methods and systems according to embodiments of the invention allow behavioral data to be overlaid on network data. Metrics can be calculated indicating the importance of a particular professional based on his or her influence on the behavior of others in his or her network. This network data and other data can then be used to define business goals and objectives, segment a customer base according to user-defined characteristics, deliver targeted marketing interventions, and understand the effects of those interventions.

### CROSS-REFERENCE TO RELATED APPLICATIONS

This application claims priority to U.S. Provisional Patent Application No. 61/550,846, filed Oct. 24, 2011, the contents of which are incorporated by reference herein in their entirety.

### BACKGROUND OF THE INVENTION

1. Field of the Invention

The invention relates to systems and methods for understanding and modeling the ways in which individuals learn, behave, and associate themselves into networks, and the ways in which those networks affect behaviors.

2. Description of Related Art

The training of professionals and the efficacy of academic curricula are oft-studied subjects. In comparison, relatively little is known about how established professionals maintain their existing skills and knowledge and learn new things. While many professions require periodic continuing education programs, and some professions require periodic examinations for continued licensing, there is less focus on where professionals get new information, with whom they associate professionally, and how groups of professionals can best and most efficiently be provided with information and advice about new techniques, products, and services.

Information on how established professionals associate with other professionals and learn new skills is valuable in a purely educational context, to study the effects of formal and informal educational programs, events, and the influences of more experienced and prominent professionals on others. However, this sort of information can be especially valuable when the professionals in question act as gatekeepers for particular products and services. For example, physicians act as gatekeepers for a plethora of prescription drugs, medical devices, and other treatments; consumers cannot use prescription drugs or many medical treatments unless a physician prescribes them and, in some cases, administers them as well. Therefore, physicians, surgeons, and other prescribing medical providers have almost complete and exclusive control over which patients use which drugs, and thus, which drugs are selected and utilized and which are not.

Most pharmaceutical companies use field representatives to supply the medical providers in particular geographical areas with information, drug samples, and product support. These representatives are generally deployed based on information such as each physician's specialty, patient volume, and prescribing history. However, in some cases, it may be that a physician has a large effect on the prescribing behaviors of other physicians, irrespective of their own prescribing activity level. Traditional data and analysis methods may fail to account for these types of factors, and do not provide good measures of a physician or other professional's full impact on the knowledge, skills, and behaviors of others with whom he or she associates.

### SUMMARY OF THE INVENTION

One aspect of the invention relates to systems and methods for modeling and analyzing learning groups and networks. In systems and methods according to embodiments of the invention, sociometric research and surveying techniques or other data sources are used to visualize and map existing learning groups and networks, and to identify different types of leaders within the network. That network data is then combined and/or overlaid with data on the behaviors of individuals in each network, including their category relevant personal prescribing information, their personal participation in educational events or programs sponsored by a manufacturer, and the sales call activity they receive. Using a variety of metrics, systems and methods according to embodiments of the invention, an evaluation of the influence of one individual on the behaviors of his or her network peers can be generated.

Another aspect of the invention relates to methods for defining goals and related tactics and tracking the progress of the defined goals. As a part of these methods, sets of user-defined criteria may be established and customers sorted into bins or categories based upon those criteria. Marketing plans may be established and directed to specific customers based on their criteria-based categories. Using specific criteria for a product or service, users can define specific triggers that define the lifecycle of a customer and his or her use of a particular product, so as to manage that lifecycle and direct specific marketing programs to customers in different stages of engagement with and/or use of the product.

Other aspects, features, and advantages of the invention will be set forth in the description that follows.

### BRIEF DESCRIPTION OF THE DRAWING FIGURES

The invention will be described with respect to the following drawing figures, in which like numerals represent like elements throughout the drawings, and in which:

FIG. 1 is an illustration of a method for modeling and analyzing learning groups and networks according to one embodiment of the invention;

FIG. 2 is a schematic illustration of a system for implementing the method of FIG. 1;

FIG. 3 is a map of a network assembled using systems and methods according to embodiments of the invention;

FIG. 4 is a profile of a provider in the network of FIG. 3;

FIG. 5 is metric listing and graph for a provider;

FIG. 6 is a high-level flow diagram of a method for goal and tactic tracking, projection, and modeling;

FIG. 7 is an illustration of a graphical user interface (GUI) allowing a user to define one or more goals;

FIG. 8 is an illustration of a GUI allowing a user to define one or more tactics;

FIG. 9 is an illustration of a GUI allowing a user to view and track the progress of goals and tactics;

FIG. 10 is an illustration of a marketing plan and action definition interface allowing a user to define a marketing plan;

FIG. 11 is an illustration of an interface for marketing planning based on customer lifecycle criteria;

FIG. 12 illustrates an informational display that details the efficacy of marketing programs; and

FIG. 13 is a schematic illustration of a system for implementing the method of FIG. 6.

### DETAILED DESCRIPTION

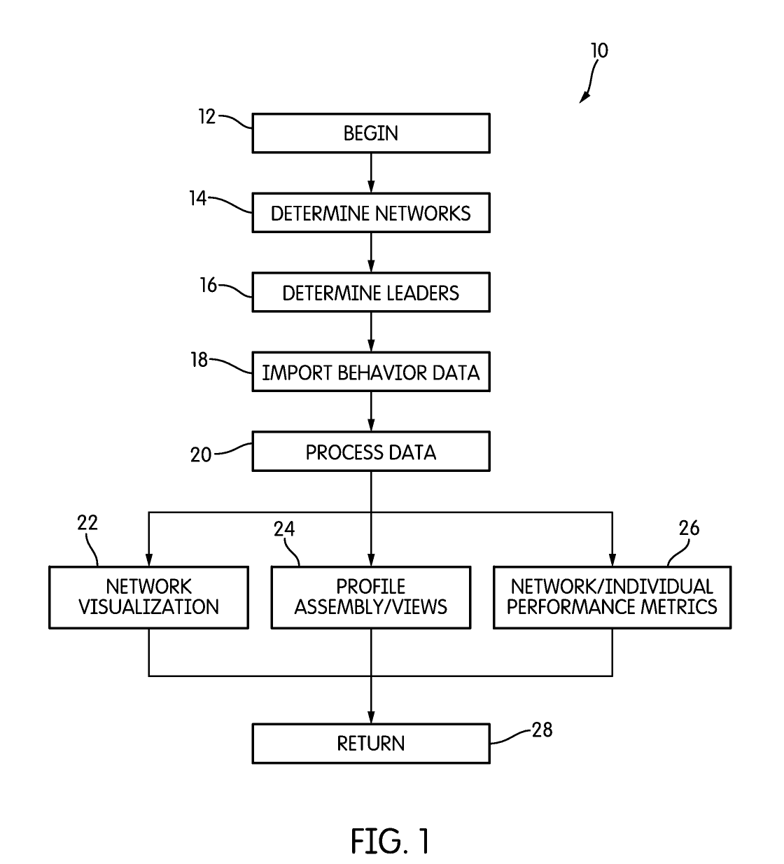

FIG. 1 is an illustration of a method for analyzing learning groups and networks, generally indicated at 10, according to one embodiment of the invention. It should be understood that method 10 may be applied to study the learning groups and behaviors of essentially any group of people, although in the following description, certain examples may be given with respect to physician groups.

Method 10 begins at task 12 and continues with task 14, in which the networks within a group or population are identified and studied. In task 16, the leaders within the networks are identified. These two tasks may be accomplished using a variety of sociometric research techniques, and are most commonly done by administering a survey to a targeted sample of individuals within the population of research interest.

One advantage of methods according to embodiments of the invention is that they can be used to determine the networks for a range of both general and specific associations between individuals. Task 14 may be used to map a general network in which individuals are in contact with one another for general professional or social reasons. However, task 14 of method 10 may be most advantageously used to determine and map very highly specific networks. For example, in a population of physicians, task 14 might be used to determine networks of physicians who treat a particular disease or condition, such as acute coronary syndrome, in a particular geographical area.

The degree of specificity in defining a network in task 14 will also depend on the objectives of the network study. If the objective is to map networks of cardiologists for educational reasons, for example, then it may not be necessary to ask about particular diseases or conditions. If, on the other hand, the objective is to use the information developed by method 10 to target marketing efforts for a particular drug or medical device, then highly specific information on a particular condition is extremely useful. As will be described below in more detail, even among the same individuals, networks that exist for different purposes may vary widely.

The networks established in task 14 may also be used to study and improve overall patient care by studying networks and how those networks align with behavioral best practices within physician groups, healthcare provider groups, and health insurance providers.

As was noted briefly above, one of the most useful mechanisms for collecting the raw data necessary to map a network in task 14 and to determine leaders in that network in task 16 is to conduct a survey. In some embodiments, survey participants may be selected at random to create a fully representative sampling of the larger population. However, in other embodiments, survey participants may be deliberately selected from a subset of a given population, and may not be intended to be fully representative of the overall population. For example, if the objective of method 10 is to improve the understanding of how a particular drug is sold and how to increase sales, prospective participants for a survey may be chosen from existing lists of physicians who prescribe the drug frequently or treat patients in need of the drug frequently. In some cases, data on prospective survey participants may be provided as a “feed” or data file from an existing database or databases (e.g., a customer database), and that feed may need to be stripped of header information or other information before it can be entered into a database and used to solicit data from prospective survey participants.

In method 10, the term “leader” is defined broadly as anyone who has influence over an individual in a particular field or subject area. A leader can be anyone who is relied upon for guidance and advice within that particular field or subject area. Moreover, in method 10 and in other methods and systems according to embodiments of the invention, it is understood that there may be more than one leader in a group, and that there may be many different types of leaders in a single network. Thus, in task 16 of method 10, the process of determining the leaders in a network may involve determining a number of leaders in a number of different categories.

For example, in physician and other professional networks, there may be four different kinds of leaders. Sociometric leaders are those to whom individual practitioners may turn for discussion or advice related to the clinical management or treatment selection of their patients. Prominence-based leaders are those who individuals within the network identify as prominent leaders within the specific disease category or specialty whether or not the individuals associate with them personally. Publication leaders are those who publish academic papers within a defined disease or specialty subject matter area or on a particular topic. Finally, formal leaders are those who hold leadership positions within academic, governmental, or private enterprises and influence opinions and behavior by virtue of their positions. In any survey administered as part of task 16, questions may be asked in order to determine all of these different types of leaders, and any other types that may be identified. However, as will be described below in more detail, surveys are not the only means by which task 16 may be accomplished, and certain categories of leaders, such as publication leaders and formal leaders, may be established by reviewing academic publication databases and publicly-available personnel listings and biographies, respectively.

Once survey participants have been selected, surveys may be administered in any convenient manual or electronic form, including on paper by mail, by electronic mail, or through a World Wide Web-based interactive survey form. Surveys used in tasks 14 and 16 may include any number of questions. A typical survey will include a number of general information questions about the individual filling out the survey, followed by questions that are specific to the network that is the subject of tasks 14 and 16. In the case of a physician survey, a survey participant may be asked his or her name, title, and address; the type of his or her practice (e.g., solo practice, hospital-based practice, group practice, learning-based institute, etc.); hospital affiliation (e.g., major academic teaching center, university affiliated/teaching hospital, large community hospital, midsize community hospital, small community hospital, VA/government hospital, etc.); and medical specialty.

If the survey is specific to a particular condition, the survey may also ask how many patients having that condition the physician treats; what percentage of his or her practice is devoted to treating patients with that condition; how many years the physician has been treating patients with the condition; whether or not the physician is accepting new patients; how many years the physician has been treating patients with the particular condition; and how many years the physician has been practicing in his or her geographic area. The physician may also be asked how many patients he or she has diagnosed with the particular condition in a particular time period; how many patients with the condition have been referred to the physician in that time period; and how many patients with the condition the physician has referred to other physicians in the time period. If the physician refers patients with the condition to other physicians, he or she may be asked why.

With respect to task 16, the survey may ask a physician to identify a number of trusted colleagues with whom he or she routinely talks to about the treatment or management of the disease or condition, a number of physicians to whom he or she would turn for expert advice on the disease or condition, and a number of physicians who he or she considers to be prominent national or international leaders in the study and treatment of the disease or condition. In each category, a survey may ask for any number of responses, and may provide space for, e.g., 7-10 physicians to be listed in each category. For each physician listed, the survey may ask for a name, specialty, and practice location. For physicians with whom the survey respondent personally interacts, the survey may also ask the average number of interactions per month.

Although some aspects of this disclosure may focus on the use of surveys to define networks and determine leaders in those networks in tasks 14 and 16, those two tasks may be performed using other kinds of data, and in some cases, information from other sources may complement information obtained by surveys. For example, as was noted briefly above, publicly available databases may be used to establish some kinds of leaders, like formal and publication leaders, instead of asking for the information in a survey.

However, in some embodiments, data from other sources may entirely or substantially replace the use of survey data. For example, data may be extracted from medical claims databases, such as Medicare and Medicaid claims databases, which detail every physician who has seen a particular patient. The patients link the physicians together into a network. Using this kind of data, links between physicians may be inferred, for example, by the number of shared patients. Referral data, indicating who refers patients to whom, may also be used to establish links between physicians. Networks established using patient or claims data will tend to be more patient-centric.

Other ways of establishing the networks between physicians include looking at professional affiliation relationships. Physicians affiliated with the same hospital or academic center may be assumed to be in the same network. Other affiliations, like which medical school or residency program a physician attended, can also be used to establish networks. Networks may also be established by looking at professional activities, like the names and affiliations of authors of publications, the principal investigator and other investigators on grant applications, and the principal and other investigators on clinical trials. Using these kinds of indirect data allows more flexibility in method 10 and tasks 14 and 16; however, the conclusions drawn from such data may not be the same conclusions drawn if the physicians in question were to be surveyed.

However tasks 14 and 16 are performed, network and leader data gathered in those can be combined with information the behavior of the individuals in the networks. In task 18 of method 10, information on the behavior of the individuals in the networks is gathered or imported.

The type of behavioral data may vary from embodiment to embodiment. Behavioral data usually includes such things as sales or use data for a product or service, number of times an individual performs or has performed a certain type of procedure, and any other relevant data that describes behaviors. For example, in the case of physicians, the product may be a drug or device, and the behavioral data may comprise data on how often each individual prescribes a given drug or uses a particular device in a procedure. Behavioral data may also comprise information on whether an individual is a paid consultant, presenter, or researcher for a company; whether they have attended any educational programs sponsored directly or indirectly by a company, and if so, which ones; the number of sales calls that manufacturer or company representatives have made to a particular physician; and the number of product samples that have been consumed. This data may come from manufacturer sales data, field notes from sales representatives, hospital data, or pharmacy data, to name a few possible sources. Any number of sources of data may be used simultaneously, as one source of data may supplement or fill shortcomings in another source.

Other types of behavioral data may be used in other embodiments. For example, if the objective of method 10 is to study the degree to which a set of defined best practices are being used within a group such as a physician group, the behavioral data may comprise any measurable process step or outcome in a case.

The next task of method 10, processing the data, will vary depending on how the data is collected. The general purpose of task 20 is to transform the data from the format in which it was gathered into a format that can be processed. If the data, e.g., sales data, is supplied from an existing database, initial steps in this process may include stripping header information and manually or automatically mapping the data into existing fields in a database.

As was described above, the data gathered in tasks 14 and 16 typically includes lists of professionals who form each individual's network. The behavioral data imported in task 20 will typically contain an individual's name or other identifying information coupled with a number of records or datapoints characterizing the individual's behavior, often from disparate sources. For example, a drug manufacturer may have a unique identifier assigned to each physician or provider in its own sales records. However, third-party vendors, who may have their own identifiers for the attendees of such programs, or no identifiers at all, may run educational programs. In addition to those sources, there are broader recordkeeping systems that contain the name of every, or essentially every provider in a legal jurisdiction. For example, the National Plan & Provider Enumeration System (NPPES) in the United States assigns a unique national provider identifier (NPI) to every provider. Similarly, state professional licensing boards typically assign their own license numbers. Some drug manufacturers or other entities may also maintain their own “universe” files of all known physicians or providers.

One goal of task 20 is to create a single, unambiguous record for each individual, so that networks can be clearly established, and to associate the behavior data with each individual record. In some cases, this can be done by matching existing records with one another. In other cases, however, it may be necessary to use an automated fuzzy logic-matching algorithm to associate a unique identifier with a record. For example, the names of individuals may be misspelled, or the same individual may be referred to differently, e.g., with or without a middle initial, with or without a middle name, or by an abbreviated first name or nickname. That mismatched data is matched in task 18 with existing records. In some cases, the data may be preserved as the individual originally supplied it, but that data may be linked with a correct master record. Thus, after a matching process, “John Doe,” “John A. Doe,” and “J. A. Doe” might be understood to be the same individual if other information available about each individual was a match or a near-match.

A matching algorithm may be based on geographical information, name information, or any other available information, with more weight given to data sources known or believed to be authoritative. Typically, a matching algorithm will output individuals known or believed to be the same, along with a confidence measure indicating how confident the system is that the individuals named are the same person.

Once the individual data gathered in tasks 14 and 16 is processed and disambiguated, the relationships between individuals are also stored. If, as described above, each individual is asked to name 7-10 sociometric leaders, 7-10 practice leaders, and 7-10 formal and/or publication leaders, then each individual has, in essence, specified three or four distinct social networks. The relationships identified in tasks 14 and 16 are stored along with the individual data in an appropriate data repository, such as a database. Additionally, the locations of all of the individuals are stored.

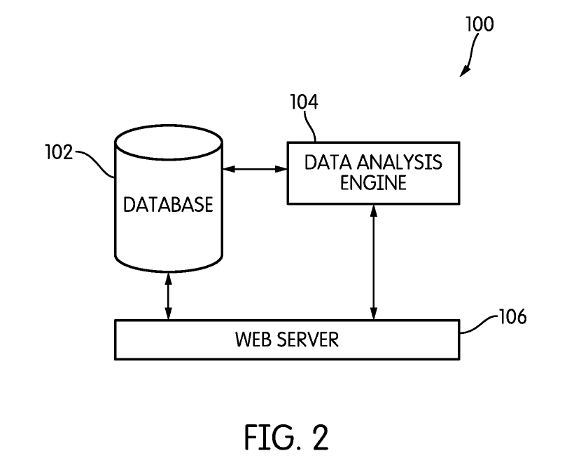

The tasks of method 10, including tasks 12-20, may be performed on any of a variety of systems. FIG. 2 is a schematic diagram of a system, generally indicated at 100, for accomplishing the tasks of method 10. Generally speaking, methods according to embodiments of the invention are performed using one or more computing systems. As shown in FIG. 2, a system 100 according to one embodiment of the invention includes a database 102, a data analysis engine 104, and a web server 106. Although shown separately for ease of illustration, the components 102, 104, 106 of system 100 may be implemented using a single computer or machine, they may be implemented in multiple computers configured to act as a single logical machine, or they may be implemented in a more distributed network of machines. The machine or machines used to implement system 100 may be any machines with sufficient memory and processing power to implement the tasks described here.

The database 102 may be, for example, a structured query language (SQL) database with tables containing individual data and behavioral data. As those of skill in the art will realize, a number of database schemas and data models are available for storing social network data, and any appropriate data model or schema may be used. Of course, as those of skill in the art will realize, any type of database system may be used, whether structured or unstructured.

The web server 106 acts as a front end and interface for system 100. The web server 106 would typically be a computer connected to a network, such as a corporate intranet or the Internet, that is running Web server software, such as APACHE Web server software. The use of a network server, such as web server 106, and a communications network facilitate remote implementation, viewing, and usage of method 10. However, these components are optional. In some embodiments, method 10 may be implemented on a standalone computing system that uses a local compiled or interpreted application as a front end. A standalone system may also implement web server software without being connected to a network, in which case, browser software on the computer may load local files provided by the server software.

In addition to allowing access to the processed data, as will be described below in more detail with respect to method 10, the web server 106 may also provide an interface for the administration of surveys used to gather data in tasks 14 and 16 of method 10. In that case, individuals would be provided with a uniform resource locator (URL) pointing to an interactive survey hosted by the web server 106. For that reason, in some embodiments, system 100 may also include an e-mail server, such as a simple mail transfer protocol (SMTP) server, to e-mail prospective participants. An e-mail server may also be useful in communicating with individuals authorized to use system 100.

The data analysis engine 104 typically comprises a number of routines stored on a machine-readable medium that, when executed, cause the machine to perform data analysis tasks. The data analysis engine 104 may be responsible for the data processing of task 20 of method 10, as well as later data analysis and visualization tasks. The data analysis engine 104 may include any number of data analysis routines or algorithms.

With respect to the tasks of method 10 of FIG. 1, once the data has been processed, a number of visualization, viewing, and analysis tasks can take place. As indicated in task 22, the networks of leaders and individuals can be visualized using network visualization routines. In some cases, other data may be overlaid on the network visualization.

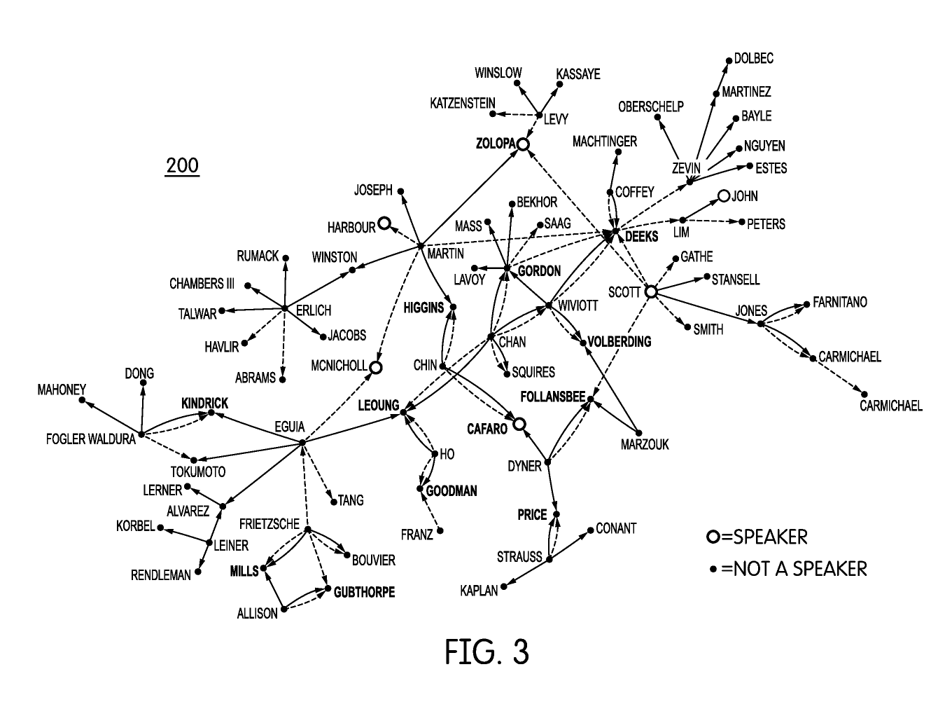

As one example, FIG. 3 illustrates a network map of health care providers (HCPs), generally indicated at 200, who responded to a survey. In the map 200 of FIG. 3, providers are included in the map 200 whether or not they completed a survey. Arrows between providers in the map 200 indicate the direction of the relationship, and colored nodes are used to convey additional information, in this case, whether or not the provider is a paid speaker for a particular drug or topic. As FIG. 3 indicates, maps like map 200 may be useful in deciding whether marketing and educational dollars are well-spent; some of the providers who are indicated as speakers are at the center of relatively large networks, and can thus be presumed to be a good investment, while other compensated speakers do not have large networks and may not be considered to be good investments. Still other providers indicated in FIG. 3 are not compensated speakers, but have large networks and thus might be considered for future programs.

As shown in FIG. 1, in task 24 of method 10, profiles are assembled for each individual in a network. The first steps of this process begin with the kind of disambiguation and identification of unique individual described above. Ultimately, a profile may contain information any or all of the information collected by survey or available in any of the other data sources mentioned above. A profile may also indicate how many individuals nominated the named person as a leader in the various categories, his or her prescribing habits, and any other useful information.

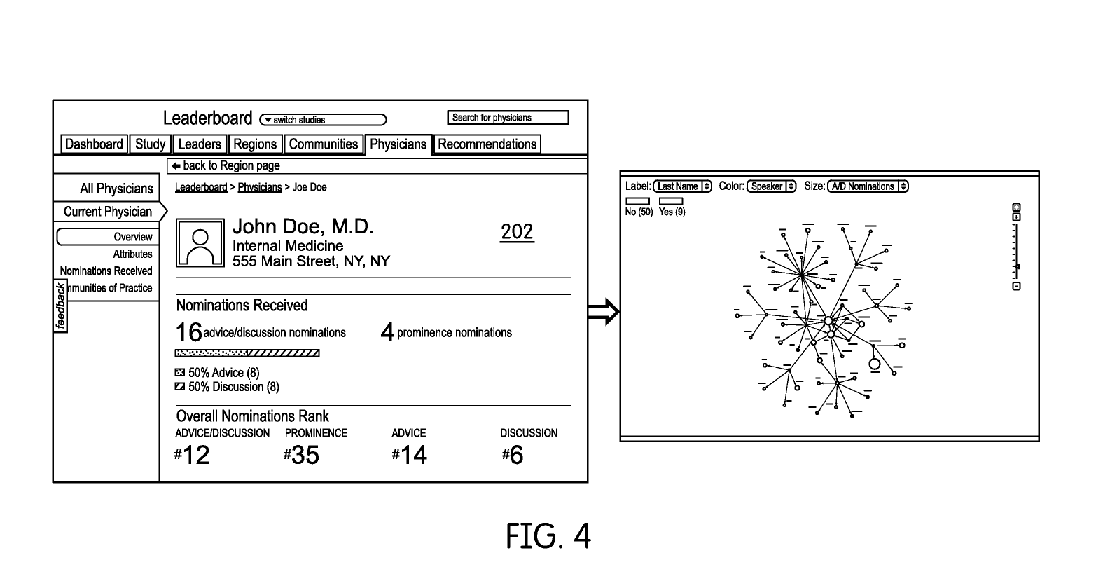

FIG. 4 is an illustration of a profile, generally indicated at 202, for one provider. The profile 202 contains information on the provider's name, address, specialty, category leader nominations and rank, and provides space for other attributes. Depending on the particular user interface that is used, clicking on an individual's node in a network visualization map, such as the map 200 of FIG. 3, may bring up a profile listing like profile 202.

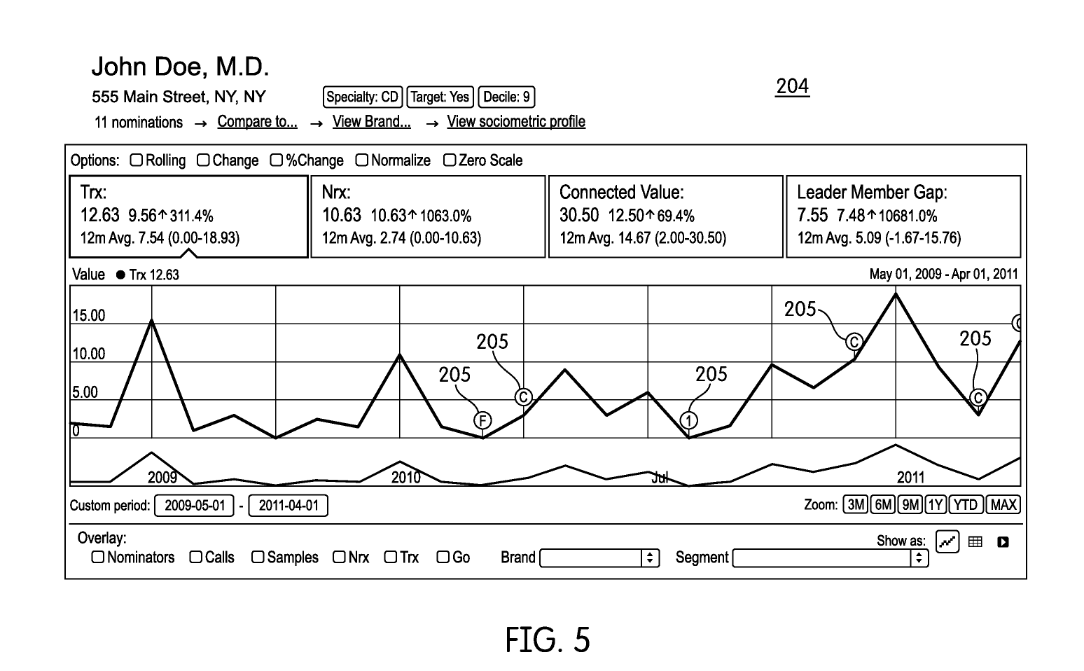

As shown in task 26 of method 10, systems and methods according to embodiments of the invention also allow for the use of a number of individual and network performance metrics. FIG. 5 is an illustration of one metric listing and graph, generally indicated at 204, for a provider. The data shown in the metric listing and graph 204 relates to the provider's behavior with respect to a single drug; other listings and graphs may be assembled for the provider with respect to other drugs, treatments, and goods.

The metric listing and graph 204 includes four main metrics, referred to as Trx, Nrx, connected value, and leader/member gap. Trx refers to the total number of prescriptions written for the drug in question. Nrx refers to the number of new prescriptions for the drug (as differentiated from ongoing prescriptions for patients who are being maintained on a drug). These two metrics are usually established from the behavioral data imported in task 18 of method 10, and both are well known in the pharmaceutical industry. It should be understood that while certain aspects of this description may focus on Trx, Nrx, and other metrics derived from them, any metrics known to and used by those of skill in the art may be used in the course of method 10.

A particular advantage of method 10 is that it allows one to determine how the behavior of a leader affects the behavior of individuals in the leader's network. Thus, in task 26, at least some of the metrics that are calculated relate to the performance of individuals in a network relative to a network leader, or vice-versa. These metrics may involve or use any of the behavioral data imported in task 18.

In the illustrated embodiment, connected value and leader/member gap are calculated metrics based on the provider's network. Connected value establishes the average Trx or Nrx for the provider's network. Leader/member gap is a network-based, computed metric in which the average prescribing behavior of the provider is subtracted from the average prescribing behavior of those in his or her network, in order to determine the gap between the leader's behavior and the behavior of those connected to the provider. For example, if the provider is a strong prescriber of a particular drug but those in his or her network or not, it may be appropriate to plan an educational program and invite the people in that network.

The above are brief examples of the kinds of network-based metrics that may be computed based on behavioral data. As those of skill in the art will realize, there may be great variations in how metrics are calculated from embodiment to embodiment, and even from situation to situation. For example, in some cases, instead of taking an average of everyone connected to a provider in calculating a metric, the system may weight the values depending on the degree of separation between the provider and the other individual in the network. In that case, e.g., the behavioral data of first-degree connections may be weighted at 100%, the second-degree connections may be weighted 50%, and the third-degree connections may be weighted 33%. Social network research may be used to establish appropriate weights for a particular network. These and other metrics may be calculated for any particular period of time, such as the last 12 months, last quarter, last year, etc., depending on availability of data.

Although the above metrics focus on combined behavioral data and network information, other metrics that are not directly or partially network-based may also be calculated. For example, it may be useful to know the physician's prescribing behavior (Trx or Nrx) normalized or divided by the number of sales calls that the provider has received in a particular period, such as the last 12 months. It may also be helpful to normalize the metrics by the prevalence of the particular disease or condition treated by a drug in the provider's geographical area, if the drug, treatment or other goods are limited in use to a particular treatment or treatments. Alternatively, instead of normalizing the data, a geographical prevalence index could be presented along with the other data.

In addition to the numerical metrics, the metric listing and graph 204 displays a graph showing behavioral trends over time. This graph may be of any of the individual metrics, and may display several of them on the same axes for evaluation purposes. Additionally, markers 205 indicating marketing activity or programs, like educational programs, sales visits, major news articles, etc., may be overlaid on the graph, as shown in FIG. 5, in order to allow a user to understand what happened to the behavior of the provider (and, if applicable, to the behavior in the provider's network) after the event. In particular, a group of selection controls under the graph allow a user to control which metrics are shown and overlaid on the graph over what time period.

In addition to viewing individual leaders and their metrics, the system may display a listing of all leaders and their metrics. In general, the data may be presented and viewed in any way that is advantageous or convenient.

With respect to the tasks of method 10 of FIG. 1, tasks 22-24 may be repeated as much as necessary as users parse the data to identify trends and plot strategies around the identified trends. Method 10 concludes at task 28.

### Goal and Tactic Tracking, Projection, and Modeling

Method 10 and the description above focus on the establishment of relevant networks and the identification of network leaders who influence the behaviors of individuals in a network. Methods and systems according to embodiments of the invention may also be used to create and track specific business goals and objectives, and to make projections.

As the phrase is used here, “business goals and objectives” may refer to any goal or objective a business or organization may have, at any level. These goals may be relevant to the business or organization as a whole, to a division or sub-unit of the business, or to a particular product or products. Some of the business goals and objectives may relate to the networks established using method 10, while other goals and objectives may be more general, and may relate to the networks only tangentially, or not at all.

Examples of goals and objectives include increasing revenue to a specific dollar amount or by a particular percentage, increasing sales to a specific dollar amount or by a particular percentage, and increasing market share of a product or products to a specified level. With respect to pharmaceuticals and the description above, more product- and network-specific goals might include increasing the market share of a particular drug, increasing a particular provider's Trx or Nrx for a particular drug by a specific percentage, increasing a particular network's Trx or Nrx by a specific percentage, and increasing the Trx or Nrx for a particular drug in a particular geographic area by a specific percentage. Of course, many other goals and objectives will occur to those of skill in the art, and any of those goals and objectives may be tracked.

Systems and methods according to embodiments of the invention may also track tactics. As the term is used here, “tactics” refer to specific steps taken in order to achieve stated goals and objectives. For example, if one stated goal is to increase the market share of a particular drug by 10%, appropriate tactics might be things like increasing sales calls on physicians by 25%, increasing free sample distribution by 25%, increasing marketing and speaker programs by 15%, and increasing encounters with experts by 25%. Any number of tactics and tactical goals may be associated with a particular goal or objective, and depending on the embodiment and the particular installation, there may be a hierarchical arrangement of one or more larger goals and smaller sub-goals, with any number of tactics associated with each of the goals in the hierarchy.

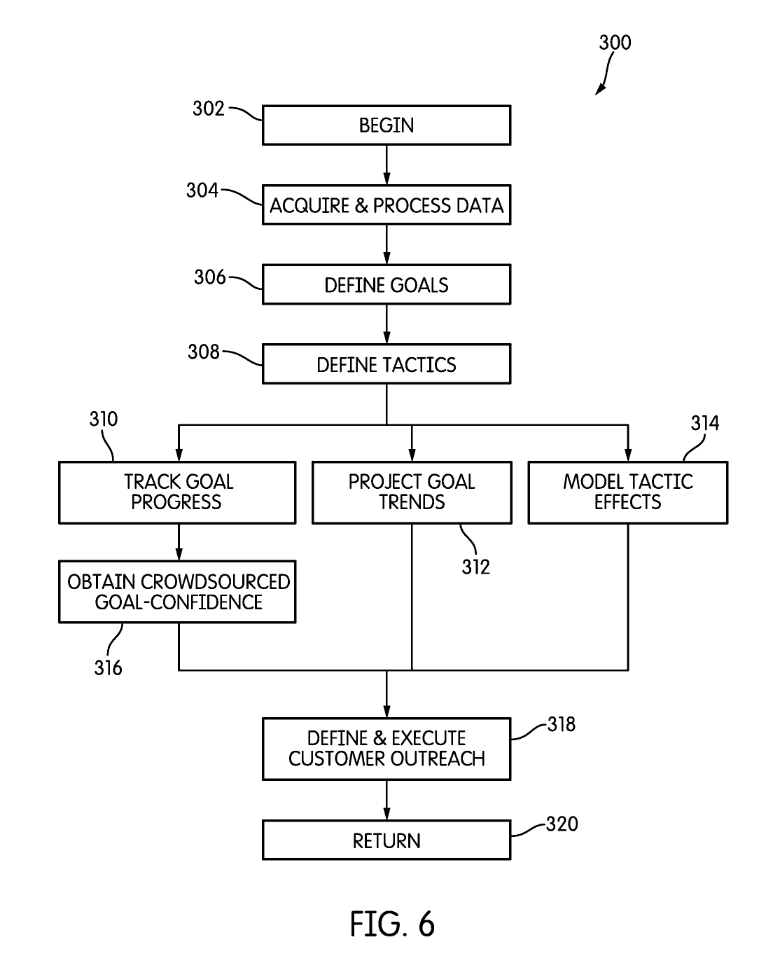

FIG. 6 is a flow diagram of a method of creating and monitoring business goals, objectives, and tasks, generally indicated at 300, according to an embodiment of the invention. Method 300 begins at 302 and continues with task 304. Method 300 operates on a set of business data to allow a user to visualize and understand that data, establish goals and tactics, and track the progress of those goals and tactics. Thus, once method 300 begins in task 302, it continues in task 304 by acquiring and processing relevant data sets.

The data acquired and processed in task 304 of method 300 may be any data sets that are relevant to the goals and tactics that are to be established and monitored. Examples may include sales data, prescribing data, inventory data, revenue data, expense data, workforce utilization data, and any other forms of data that are relevant to the particular business in question. In particular, in many embodiments, at least some of the data will be the same data acquired and processed in the course of method 10, described above. That is, one advantage of method 300 is that one can use and integrate data on networks and behaviors with other business data to set and monitor goals and tactics. In fact, as was noted briefly above, some or all of the goals and tactics set and monitored in method 300 may relate to the networks and behaviors that are established as a part of method 10. For that reason, task 304 may involve performing some or all of the tasks of method 10, including establishing networks of individuals and profiles for those individuals, if method 10 has not already been performed.

As with method 10, when acquiring data to use for method 300, it is possible that that data may require the kinds of formatting, disambiguation, and pre-processing tasks described above with respect to method 10, and any or all of those tasks may be performed as a part of data acquisition task 304.

Although method 10 and method 300 need not be interdependent, and method 300 may operate on any set of data, synergistic and beneficial functions may be realized if the two are used together. In that case, the result at the end of task 304 of method 300 is much like the result of method 10—the user has access to a set of data that can be visualized in terms of individuals in a network the leaders of that network, and the effects of behaviors on outcomes relevant to the organization. Once that set of data is fully processed and available, method 300 continues with task 306.

In task 306, the user defines one or more goals. Goal definition can be performed in any number of ways. As with other tasks of methods according to embodiments of the invention, this task may be performed using a graphical user interface. That graphical user interface may be provided within a Web browser as a part of a World Wide Web site accessible over the Internet, or it may be provided by software on an individual computing device or a local area network. Particular systems for accomplishing the tasks of method 300 will be described in more detail below.

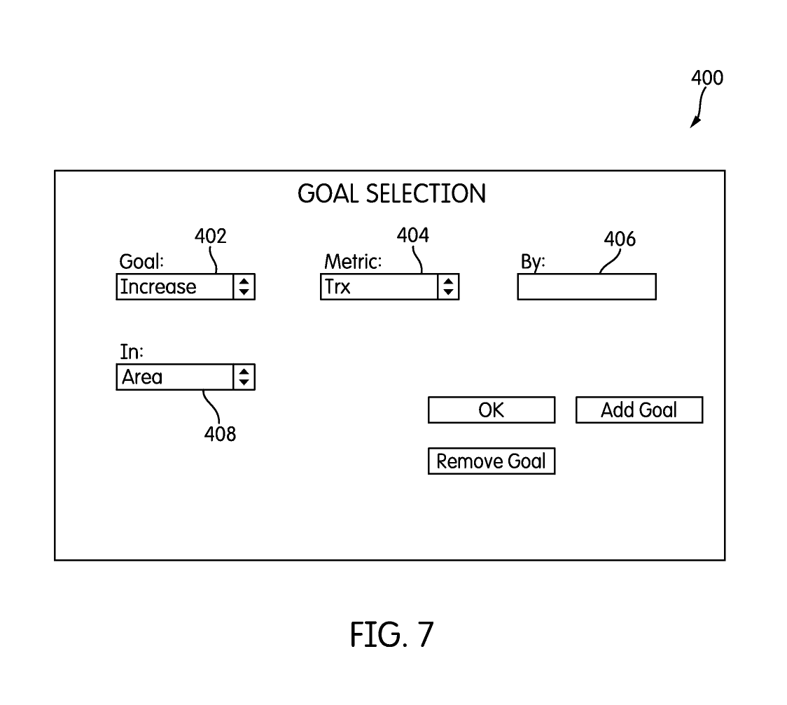

FIG. 7 illustrates a goal selection interface, generally indicated at 400. The goal selection interface 400 gives the user the ability to define particular goals. As an example, one particular goal might be to “increase Trx by 25% in all geographic areas.” In the illustration of FIG. 7, the user defines goals using the interface 400 by selecting goals from a number of list boxes. The goal type list box 402 allows the user to select the type of goal—generally “increase,” “decrease,” or “equal,” as in “make equal to a particular value.” The metric selection list box 404 allows the user to select from among all of the metrics that are tracked and available. A value entry box 406 allows the user to enter the value of the goal to be met (e.g., 25%). Finally, there may be a number of additional list boxes or other selection tools 408 that allow the user to narrow the goal with respect to a particular geographical area, a particular subject population, a particular corporate division, etc.

The nature of the graphical or textual elements that allow the user to define goals are not critical. In some embodiments, radio buttons may be used, and in yet other embodiments, the user may type the name of the goal or metric and be allowed to select the goal from a menu that is instantiated and populated as the user types. If natural language processing capabilities are included, the user may be able to define a goal simply by entering it in sentence form.

An advantage of a goal selection interface like interface 400 is that the selection tools are populated only with those goals, metrics, and other data elements that are defined in the available data. This prevents the user from defining a goal that cannot be tracked and addressed by the system. Depending on the embodiment, software routines may verify the user's input as he or she enters it. For example, once the user selects a metric, like Trx, using selection box 404, selection box 408 may be populated with only the geographical areas in which sufficient data is available to track and verify the goals in question. Similarly, if the user's goal is to set a particular metric equal to a particular value, the system could check contemporaneously to see whether the value that is provided is out of range and whether the value is of the correct type.

Goal selection interface 400 allows the user to define any number of goals, and includes controls for adding additional goals 410 and removing a goal 412, if there is some error during goal definition. Once goals are defined in task 306, method 300 continues with task 308, in which the user defines tactics.

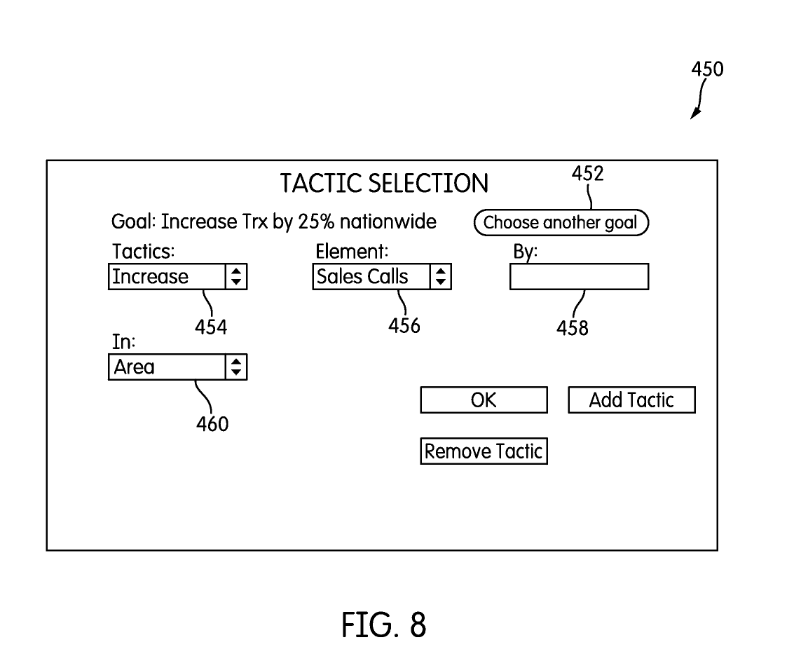

Tactics may be defined in generally the same way as goals. FIG. 8 illustrates a task selection interface 450. The task selection interface 450 allows a user to choose tasks relevant to a particular goal. The goal is displayed at the top of the interface in this embodiment, with a selector 452 allowing the user to choose another defined goal. As an example, a tactic relevant to the goal described above might be “increase sales calls by 25% nationwide.” The user can choose the tactic type, the element or metric that is to be tracked, the target value, and the additional options using the various selection controls 454, 456, 458, 460.

In some embodiments, goal and tactic selection may be integrated into a single interface. In those cases, a user could define a goal and the relevant tactics in the same interface or on the same screen.

Although the goals and tactics described above are relatively general in nature, more complex goals may be set that leverage the data from the networks established in method 10. For example, a user might define as a goal increasing Nrx for a particular drug 10% in a particular geographical area, amongst medical providers with certain demographic or sociographic characteristics, or amongst medical providers affiliated with a particular hospital or hospital group. A tactic in that case may involve increasing sales calls among leaders in the relevant networks.

Once tactics are defined in task 308 of method 300, method 300 continues with three tasks that may be performed as desired, either concurrently or separately. These tasks include tracking goal progress (task 310), projecting goal trends (task 312), and modeling the effects of various tactics and scenarios (task 314).

For purposes of task 310, it is assumed that the data used for method 300 is regularly updated. Data updates may be provided hourly, weekly, monthly, or at other regular intervals, depending on the embodiment, the situation, and the type of data. For example, sales and prescribing data may be updated on a monthly basis, data from sales calls may be updated weekly or on an ad hoc basis as sales calls are completed, and attendance at speaker programs and other marketing events are updated as attendance and other records from those programs become available.

Task 310 involves comparing the existing, new, and updated data with the goals and tactics that have been specified to determine whether or not the goals are progressing as expected. In tasks 306 and 308, individual goals and tactics were defined. Either as a part of those tasks or as a part of task 310, those goals and tactics may be broken down into sub-goals and sub-tactics. The sub-goals and sub-tactics may be used in task 310 to determine whether or not the data indicates that the users or organization are progressing toward meeting the goal. For example, if the defined goal is to increase sales 12% over a year, task 310 might define sub-goals of 1% increase per month. Of course, a user may manually define sub-goals or monthly goals, which may be particularly useful if the goal in question is tied to a particular business cycle, if steady increase is not to be expected, or for other reasons. Alternatively, task 310 may use regression analysis or other statistical techniques to fit historical data to a curve and then use that historical data to determine piecewise sub-goals over a particular period of time.

Task 310 may be intertwined with task 312, projecting goal trends. As a part of task 312, historical data relating to the defined goals may be displayed. For example, if the goal relates to sales, past sales data may be displayed in textual or graphical form and compared with year-to-date (or other period-to-date) sales information. Task 312 may also use statistical and modeling tools like regression analysis to model the current data, fit that data to a line or curve, and project the end result if progress continues at the same rate.

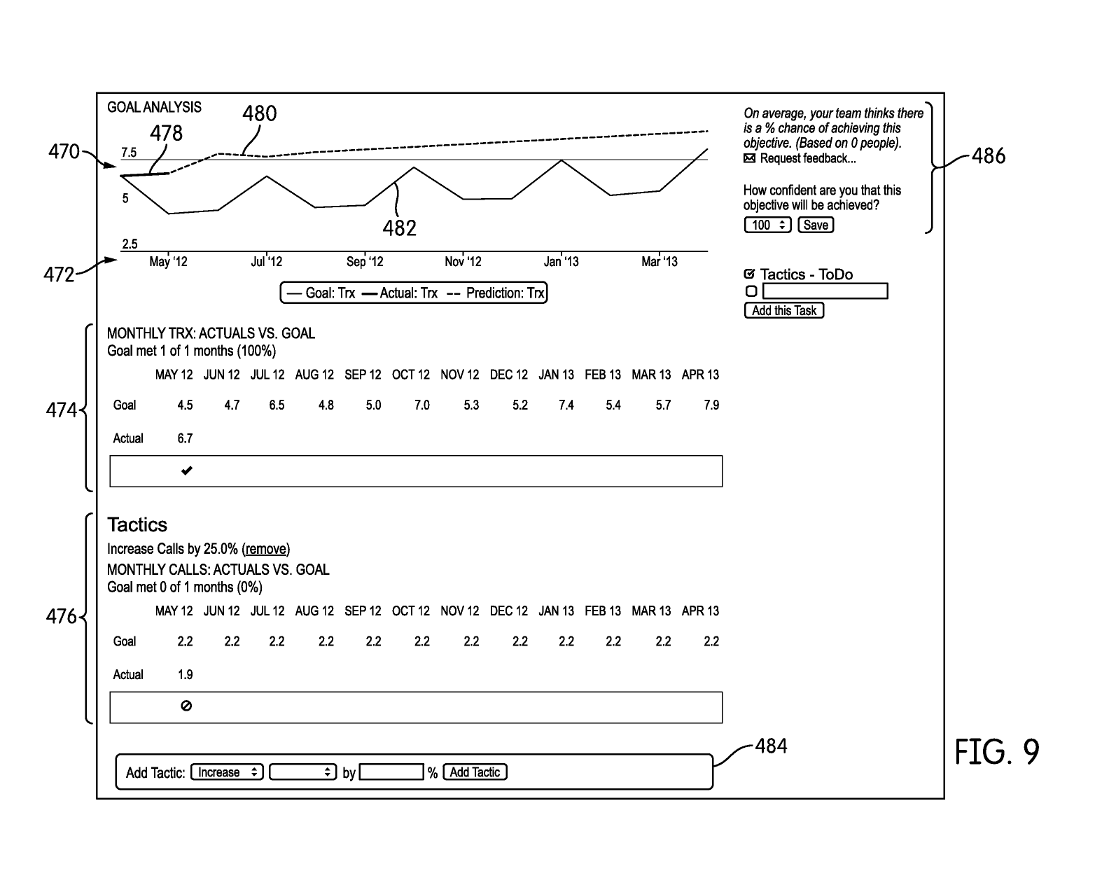

The monitoring and projecting of tasks 310 and 312 may be combined into a single graphical user interface for convenience in monitoring the goals and tactics. FIG. 9 is an illustration of a combined graphical user interface, generally indicated at 470, that allows a user to perform several tasks of method 300, including tasks 310 and 312. Interface 470 includes a graphical data display 472 that displays several types of data on the same axes, a textual goal data display 474, and a textual tactics data display 476, among other elements.

The graphical data display 472 displays a first data line 478 indicating the actual data that has been collected for the current period of time, in this case, Trx data. A second projection line or curve 480 projects what the data is likely to be if the values continue to increase or fall at the same rate, and a goal data line 482 graphically illustrates the goals. In the illustration of FIG. 9, the actual Trx data line 478 shows values greater than the goal values, and the projection line 480 shows that the actual Trx values will beat the goal values 482.

The textual goal data display 474 of FIG. 9 gives a month-by-month breakdown of the goal and an indication of whether or not the goal was met each month. For example, the textual goal data display 474 indicates that for May of 2012, the Trx goal was 4.5, whereas the actual Trx value for that month was 6.7, exceeding the goal.

The textual tactical data display 476 of FIG. 9 gives a similar month-by-month breakdown of the tactic or tactics related to the goal, in this case increasing sales calls by 25%. The data indicates that although the May, 2012 goal was met, the May, 2012 tactic of increasing sales calls 2.2% was not met—only a 1.9% increase in sales calls actually occurred.

As was noted above, the interface 470 has additional features, including an add tactic form 484 that allows a user to add a new tactic that is then tracked as a part of method 300.

Although the description of methods 10 and 300 above focuses on the actions of a single user interacting with a system and performing some tasks of the methods, as those of skill in the art will understand, these systems and methods are particularly suited for organizations that may have several or many different users in different positions and with different levels of responsibility. Therefore, in some embodiments, goals may be directed to particular divisions or individuals, rather than merely being set in general.

Additionally, as shown in task 316 of method 300, and in FIG. 9, method 300, and other systems and methods according to embodiments of the invention, may provide managers with the ability to “crowd source” and obtain feedback from others in the organization, at various levels. On the right side of interface 470 are a number of feedback indicators 486, giving users viewing the data the ability to comment on it. In the illustration of FIG. 9, the first part of the feedback indicator 486 states that “On average, your team thinks there is a ______% chance of achieving this objective (Based on ______ people).” The second part of the feedback indicator 486 gives the user a chance to register their opinion as to the percentage chance of achieving the goal in question. A link is provided for a user to request feedback from his or her teammates.

Although the data provided by feedback indicator 486 is subjective in nature, it can serve to validate the data that is coming in, so that an observer has more context with which to evaluate whether the data does represent the actual trend or is an aberration. If very few members of a team believe that a goal will be met, it may be cause for revising the goal.

In task 314, a user may be able to model the effects of various tactics on the overall goal using known statistical methods and historical data, and thereby determine which tactics are most likely to affect the goals in question. For example, given historical data on increasing sales calls and that tactic's effect on Trx, task 314 would project the effects of an increase in sales calls of a specific percentage on Trx. In other examples of modeling that may be performed as a part of task 314, a user may analyze historical data to determine how strongly correlated a particular tactic, like increasing sales calls, is with achieving a particular goal. Users can then use this data in task 308 to define more effective tactics.

Tasks 310, 312, and 314 may continue for as long as necessary, and the user may return to tasks 306 and 308 to define additional goals and tactics as necessary. Either concurrently or after those tasks, task 318 may be performed.

### Customer Grouping, Planning, and Customer Lifecycle Management

As was noted above, network-based methods like method 10 tend to lead to a deep understanding of an organization's customers or of the gatekeepers, like physicians, who influence or control the behavior of customers. In method 10, customers are grouped based on their associations with other customers, and based on their leadership roles within networks. Method 300 allows customers to be grouped according to other, user-defined criteria, so that specific forms of outreach can be directed to customers or other individuals that fall within the user-defined criteria. More specifically, task 318 of method 300 allows a user to define specific criteria and then apply specific marketing plans or interventions to customers that meet those specific criteria. In other words, method 300 allows for a segmented promotional model, in which specific marketing interventions or promotions are directed at specific, user-defined segments of an organization's customer base. By allowing users and organizations to define and track business goals, method 300 also allows its users to confirm that those marketing interventions are actually working, i.e., that the organizations are getting an appropriate return on their marketing investment.

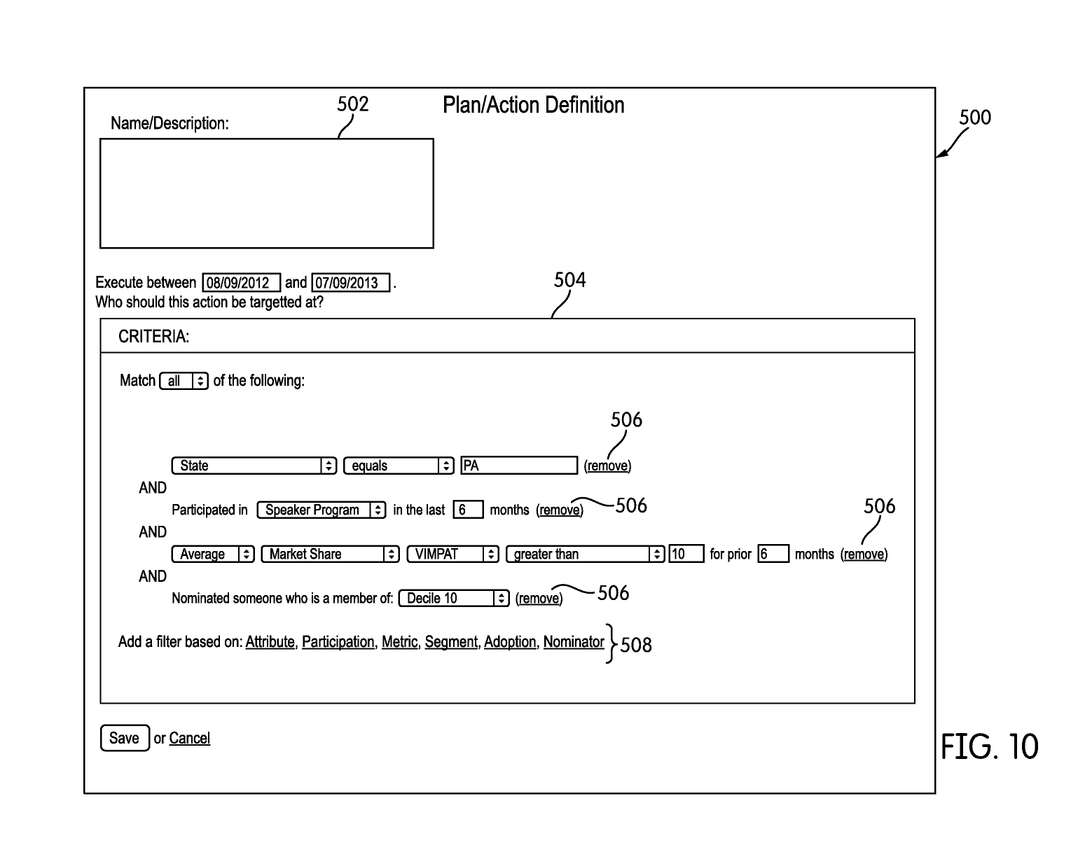

FIG. 10 is an illustration of a plan and action definition interface 500 that allows a user to define a marketing plan by defining a set of criteria or a “bin” that includes a number of customers, and, ultimately, to target customers that match the sets of criteria with specific marketing interventions. The user begins by entering a name and description for the bin, plan, or set of criteria in the name/description field 502. Below the name/description field 502 is a criteria selection area 504. The criteria selection area 504 allows the user to define any number of criteria, and to define how many of those criteria the customer must meet to fall within the bin defined by the criteria (e.g. “all criteria,” “at least one”). In the illustration of FIG. 10, a number of criteria are defined, including the customer's state, whether or not they participated in a speaker program within the last 6 months, a market share-based criterion, and a network-based criterion, in this case, whether the customer has nominated someone as a leader who is a member of a particular decile. Controls 506 next to each criterion allow it to be removed from the list, and a set of criterion/filter addition controls 508 allow a user to add new criteria based on user attributes, program participation, product- and revenue-related metrics, decile or segment, product adoption, and network nominations. Ultimately, criteria may be based on any available field of data.

Sets of criteria, which may also be called “triggers” may be created for any purpose and used to examine the available data in any number of ways. One particularly helpful way to use such sets of criteria is to define “bins” or stages in the customer lifecycle—criteria and resulting categories that define how deeply invested in a particular product a customer is, and identify those at risk of changing their habits or allegiances. Those criteria can then be used to target particular marketing and/or outreach programs.

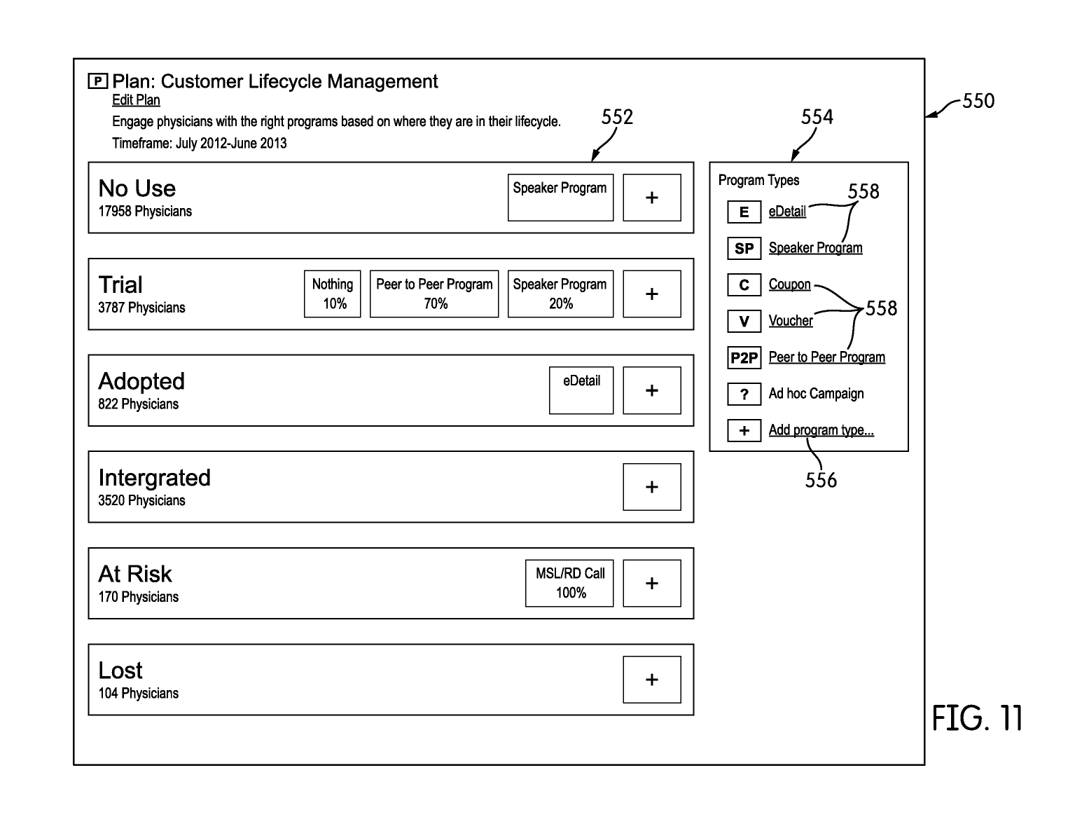

FIG. 11 is an illustration of an interface 550 for marketing planning based on customer lifecycle criteria. The interface 550 shows that six “bins” have been created based on different sets of criteria: (1) “No use”—potential customers, in this case, physicians, who have yet to prescribe a drug; (2) “Trial”—physicians who are testing a particular drug and have prescribed it to a few patients; (3) “Adopted”—physicians who have begun to use a product with some regularity; (4) “Integrated”—physicians who have fully integrated the drug into their practices and prescribe it regularly to a number of patients; (5) “At risk”—physicians whose prescribing practices for the drug in question have declined and who are at risk of changing their allegiances or product use; and (6) “Lost”—physicians who no longer prescribe the drug in question. These types of categories will have different criteria for different products, and in embodiments of the invention, the type and number of categories may differ. In this case, these categories may be defined based on specific time frames, total prescription (Trx) data, and new prescription (Nrx) data.

Once the sets of criteria or triggers are created, the customers in the database are automatically sorted into specific bins based on the sets of criteria. Once that is done, the interface 550 allows the user to select specific marketing and intervention programs for customers in each of the bins, and to define what percentage of customers in each bin are exposed to each type of marketing program. In some embodiments. In the illustration of FIG. 11, the categories 552 are on the left side of the interface, while the right side of the interface 550 provides a listing of program types 554. Each of the program types is defined by the user, and any programs may be defined. The interface 550 allows a user to “drag” a program type from the program types 554 and “drop” it on one of the categories 552 to assign that program to that category. Each category lists the number of customers in each category, and provides the user with the opportunity to determine which percentage of the customers in each category will be given each intervention.

The programs themselves will be defined for each particular product and situation. Examples of programs may include speaker programs, expert encounters, peer-to-peer programs, coupons, vouchers, direct mail campaigns, e-mail approaches, and ad hoc campaigns. A link 556 allows the user to add new programs within the interface 550. Additionally, each of the program types is accompanied by a link or control 558 that allows the user to re-define the attributes of the program. Once programs are assigned to particular categories of customers, lists of customers can readily be output and sent directly to vendors.

Programs can be applied or coordinated across any geographic subdivisions: nationally, regionally, across particular sales territories, in particular states, or in particular counties or parts of states. As programs are administered, method 300 and other systems and methods according to embodiments of the invention provide users with a robust ability to monitor the efficacy of programs. As was set forth above with respect to FIG. 5, markers 205 may be overlaid on an individual customer's behavioral data, so that the effect of a particular program on an individual and his or her network or networks can be readily seen and understood.

Once sets of criteria are established, method 300 and other systems and methods according to embodiments of the invention allow a user to measure the efficacy of the programs on a larger scale. Advantageously, systems and methods according to embodiments of the invention may be configured to track not only which bin or category a customer currently falls into, but the history of categories that he or she has been in. Thus, if certain categories are defined by users as preferable, and certain paths or transitions between categories are identified as preferable, the system can use those defined preferences to determine which programs are most effective.

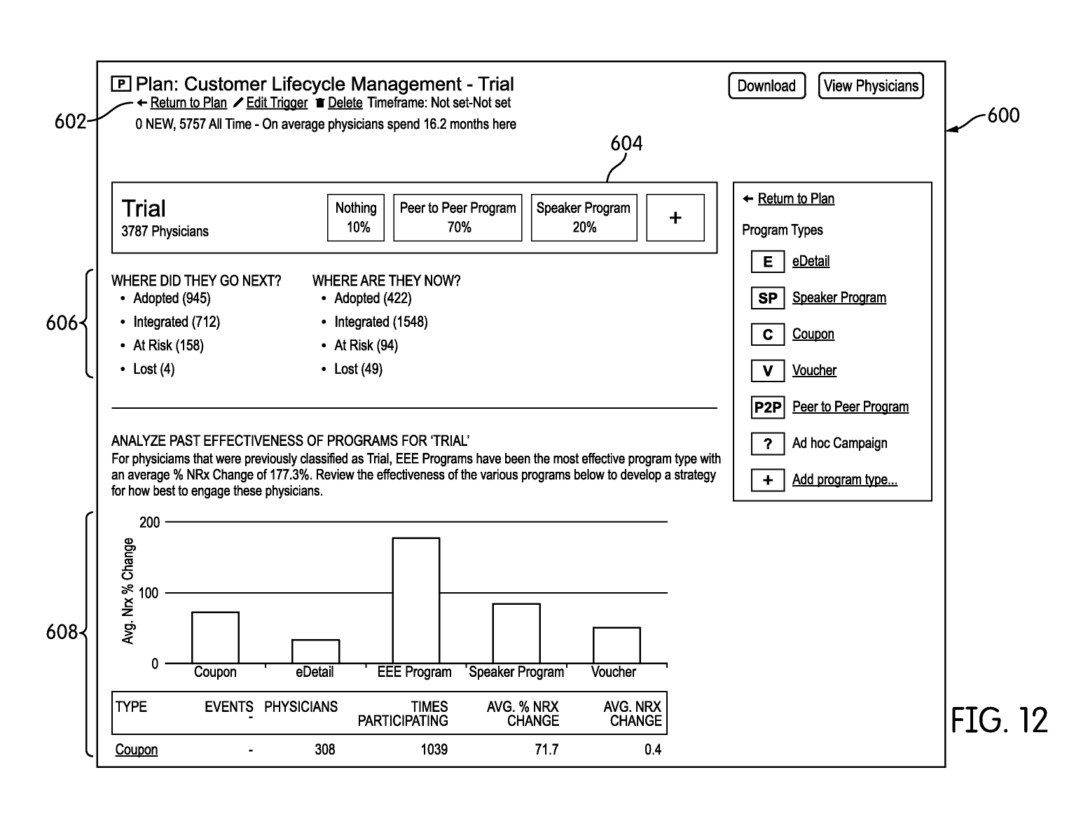

For example, FIG. 12 illustrates an informational display 600 that might be displayed if one selects the link 558 for the “trial” category. The display 600 begins with a set of links 602 that allow the user to return to the main plan display interface 550, edit the triggers or sets of criteria that define the category, and delete the category. If the category is associated with a particular timeframe, that information is displayed alongside the links. Below the links 602, a category information display 604 provides the name of the category, the number of customers in the category, and the marketing programs to which the customers in the category are exposed. The display 600 also provides a category “map” or breakdown that, for each category, explains the next category that customers transitioned into, and the category those customers are currently in.

Finally, the display 600 provides a set of marketing program efficacy indicators. Given a user-defined criterion or criteria of effectiveness, the efficacy of each marketing program is graphically and textually shown. In the illustration of FIG. 12, marketing programs are rated on their effect on Nrx, the number of new prescriptions for the drug in question. Of course, the criterion or criteria may be any, and in some cases, efficacy may be determined by network-based criteria, including the effect on new prescriptions in each attendee's network. However, given a pure Nrx criterion, the display states and shows that “For physicians that were previously classified as Trial, ______ programs have been the most effective program type with an average % Nrx of ______.” That same information is displayed in tabular form.

Method 300 concludes with task 320. As those of skill in the art will understand, the interfaces used and described in the above in the course of method 300 may vary in their appearance, configuration, and the information that they present.

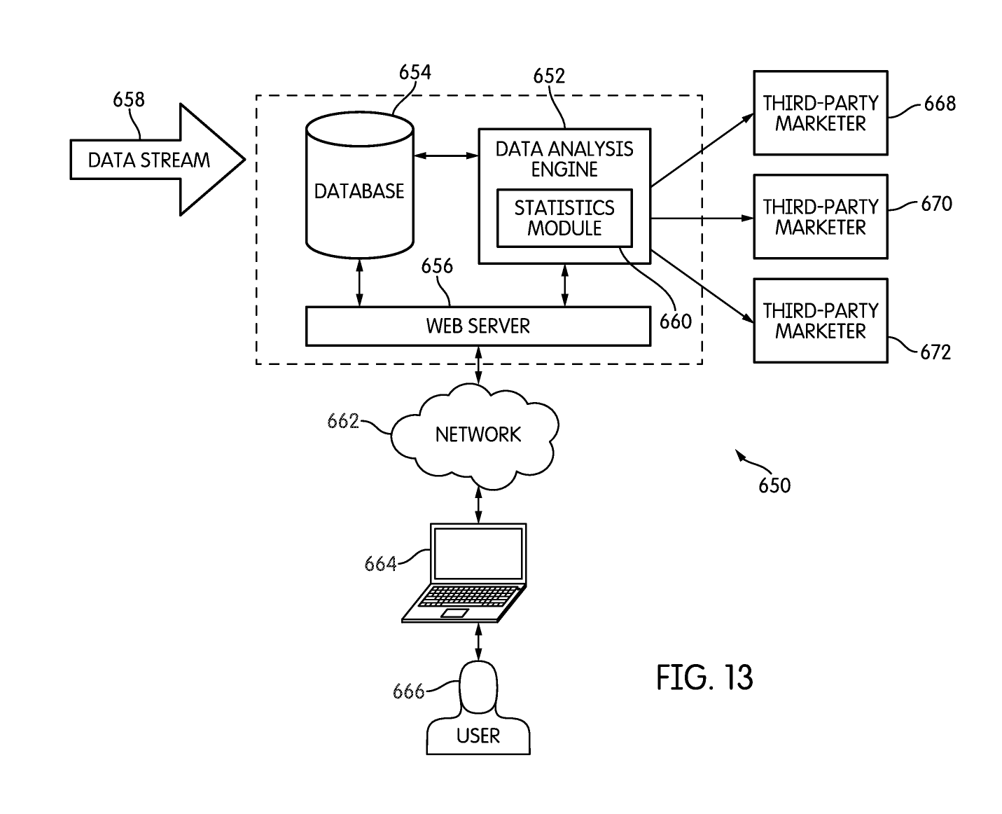

FIG. 13 is a schematic diagram of a system, generally indicated at 650, for performing methods according to embodiments of the invention, including method 300. As with system 100 of FIG. 2, much of the computing is performed by a data analysis engine 652 coupled to a database 654 and a Web server 656. The data analysis engine 652 and the Web server 656 may be the same computing machine or different machines. Moreover, each of these components 652, 656 may be a single machine or a group of networked machines that act in concert. In some cases, networked machines may be configured to act as one logical machine. The database 654 may be implemented as a set of software routines operating on either the Web server 656 or the data analysis engine 652, or it may be implemented on one or more other machines. Although shown as linked together, as those of skill in the art will appreciate, the components 652, 654, 656 may be located remotely from one another and may be connected via a communications network, such as the Internet or an organization's internal intranet.

In some embodiments, the data analysis engine 652, database 654, and Web server 656, may be implemented by a single organization that provides the software and functions described above and maintain the hardware 652, 654, 656. In other embodiments, the hardware components 652, 654, 656 may be part of a commercial data center that are rented and shared with other users.

The database 654 may have the same characteristics as the database 102, and may be either a structured database, such as a SQL database, or an unstructured database. The data analysis engine 652 processes a data stream 658 including user and product data, and establishes and maps the networks described above with respect to method 10. As was noted briefly above, data may be provided continuously or at periodic intervals. The data analysis engine 652 also sorts customers into bins by applying user-defined sets of criteria, as described above with respect to method 300. As shown in FIG. 13, the data analysis engine 652 may be coupled to or include a statistics system, module, or package 660 to perform the regression analysis and modeling tasks described above. One suitable statistics package is the R statistical computing environment (The R Foundation for Statistical Computing, Vienna, Austria), which has packages that allow it to interface with a Web server.

In a typical embodiment, system 650 is implemented as a Web-based application using an application framework like the Ruby on Rails application programming framework, although the particular language in which the system and methods are implemented is not critical and may vary from embodiment to embodiment. That application framework handles the tasks of methods like methods 10 and 300, retrieving and processing information from the database 654, and making calls to the statistics module 660 for specific statistical, regression, and modeling computations.

The Web server 656 generates the kind of interfaces shown and described above. Typically, this is done by generating hypertext markup language (HTML)/cascading style sheets (CSS) which are transmitted over a network 662, such as the Internet, to the computing device 664 operated by a user 666. Most often, data from the Web server 656 is transmitted by hypertext transfer protocol (HTTP) over transmission control protocol/Internet protocol (TCP/IP), and is interpreted by a browser running on the computing device 664. The computing device 664 may be a desktop computer, a laptop computer, a tablet computer, a smart phone, or any other device capable of creating the interfaces.

In addition to communicating information to users 666, data from method 300 may be communicated directly to any number of third-party marketers 668, 670, 672 who create and manage the marketing programs described above. Thus, method 300 may produce a list of customers who are to be exposed to a particular marketing program based on defined sets of criteria, and that data may be forwarded electronically or otherwise to the marketers 668, 670, 672 for appropriate action.

Although the above description focuses on pharmaceuticals, the product or products in question need not be pharmaceuticals. The products in question may be pharmaceuticals, medical devices, medical supplies, or essentially any consumer product. Moreover, while some of the description above focuses on the use of a single product or a closely related group of products for a single purpose, as is the case with a drug approved and marketed to treat a particular condition, systems and methods according to embodiments of the invention may use data in the aggregate, especially when tracking broader goals that may implicate multiple products and product lines.

While the invention has been described with respect to certain embodiments, the description is intended to be illuminating, rather than limiting. Modifications and changes may be made within the scope of the invention.

What is claimed is:

1. A method of marketing a product, comprising:
collecting one or more sets of criteria using a first computing system;
applying the one or more sets of criteria to a set of individual records to separate the set of individual records into two or more groups of individuals;
collecting definitions of marketing interventions supplied by a user, the definitions being created using the first computing system or a second computing system; and
using the first computing system, the second computing system, or a third computing system, applying the marketing interventions to specific ones of the two or more groups of individuals based on user input to generate lists of individuals for each of the marketing interventions.

2. The method of claim 1, further comprising supplying the lists of individuals to one or more marketers.

3. The method of claim 1, wherein the set of individual records comprises behavioral records relating to the sale of a product.

4. The method of claim 1, wherein the set of individual records comprises information linking one or more individuals into associative networks of individuals.

5. The method of claim 4, wherein at least one criterion of the one or more sets of criteria relates to characteristics of the associative networks of individuals or behaviors of the one or more individuals in one of the associative networks of individuals.

6. The method of claim 1, further comprising:
providing an interface that allows a user to define the one or more sets of criteria using a computing device connected to a computer network; and
receiving the one or more sets of criteria at the first computing system over the computer network.

7. The method of claim 1, further comprising:
defining one or more behavioral metrics of marketing intervention efficacy;
collecting information related to the one or more behavioral metrics of efficacy for each of the marketing interventions; and
determining which of the marketing interventions is most effective for each of the two or more groups of individuals.

8. The method of claim 1, wherein the criteria in the sets of criteria are one or more criteria related to attributes selected from the group consisting of product prescription frequency, product use frequency, professional specialty, geographical location, professional affiliation, past participation in marketing events, and position within an associative network with other professionals.

9. A method of marketing pharmaceutical and medical products, comprising:
preparing a database of medical providers, the database including at least a unique identification of each medical provider and at least one behavioral characteristic related to a product for each of the medical providers;
providing an interface over a computer network, the interface allowing a user to define one or more business goals related to the product and one or more tactics relating to the business goals;
collecting one or more sets of criteria related to the medical providers using a first computing system, at least some of the criteria in the one or more sets of criteria being related to the at least one behavioral characteristic;
applying the one or more sets of criteria to the database of medical providers to separate the set of individual records into two or more groups of medical providers;
collecting definitions of marketing interventions supplied by the user, the definitions being created using the first computing system or a second computing system; and
using the first computing system, the second computing system, or a third computing system, applying the marketing interventions to specific ones of the two or more groups of medical providers based on user input to generate lists of medical providers for each of the marketing interventions;
providing the lists of medical providers to marketers;
tracking the efficacy of the marketing interventions; and
tracking the progress of the goals and tactics.

10. The method of claim 9, wherein the at least one behavioral characteristic comprises a measure of the total prescriptions from one of the medical providers for a drug or device or a measure of the total new prescriptions from one of the medical providers for a drug or device.

11. The method of claim 9, further comprising defining one or more associative networks of medical providers, wherein the at least one behavioral characteristic comprises a measure of the effect of one medical practitioner on the prescribing practices of other medical practitioners.

12. The method of claim 9, wherein tracking the progress of the goals and tactics comprises comparing a numerical goal with a present value of a goal metric and displaying the comparison to the user.

13. The method of claim 9, wherein tracking the progress of the goals and tactics comprises projecting the future value of a goal metric based on available data and displaying the comparison to the user.

14. The method of claim 9, wherein said displaying the comparison to the user comprises displaying the projected future value of the goal metric in graphical form.

15. The method of claim 9, wherein tracking the efficacy of the marketing interventions comprises:
measuring the at least one behavioral characteristic of medical providers who participated in the marketing interventions after the marketing interventions;
determining which of the marketing interventions caused the greatest positive indication with respect to the at least one behavioral characteristic; and
reporting the marketing intervention which caused the greatest positive indication to the user.

16. A system for marketing and business goal analytics, comprising:
a data processing routine running on a first computing system that prepares a database of medical providers, the database including at least a unique identification of each medical provider and at least one behavioral characteristic related to a product for each of the medical providers; and
a server connected to or incorporated within the first computing system and connected to a computer network that
provides an interface over the computer network that allows a user to define one or more business goals related to the product and one or more tactics relating to the business goals,
collects one or more sets of criteria related to the medical providers from the user, at least some of the criteria in the one or more sets of criteria being related to the at least one behavioral characteristic, and
collects definitions of marketing interventions from the user;
a search and grouping routine running on the server or the first computing system that applies the one or more sets of criteria to the database of medical providers to separate the set of individual records into two or more groups of medical providers; and
an output routine running on the server or the first computing system that applies the marketing interventions to specific ones of the two or more groups of medical providers based on user input to generate lists of medical providers for each of the marketing interventions.

17. The system of claim 16, wherein the at least one behavioral characteristic comprises a measure of the total prescriptions from one of the medical providers for a drug or device or a measure of the total new prescriptions from one of the medical providers for a drug or device.

18. The method of claim 16, further comprising defining one or more associative networks of medical providers, wherein the at least one behavioral characteristic comprises a measure of the effect of one medical practitioner on the prescribing practices of other medical practitioners.
